(19) United States
(12) Patent Application Publication
(10) Pub. No.: US 2011/0265898 A1
(43) Pub. Date: Nov. 3, 2011

(54) Sealed Manifold For Air Pump System

(75) Inventor: David Delory Driscoll, JR., Milwaukee, WI (US)

(73) Assignee: Rapid Air LLC (a Wisconsin limited liability company), Pewaukee, WI (US)

(21) Appl. No.: 12/914,805

(22) Filed: Oct. 28, 2010

Related U.S. Application Data
(63) Continuation-in-part of application No. 11/869,334, filed on Oct. 9, 2007, now Pat. No. 7,886,387.
(60) Provisional application No. 60/897,616, filed on Jan. 26, 2007.

(51) Int. Cl. B67D 7/08

(52) U.S. Cl. 137/565.16

(57) ABSTRACT

A multiple configuration air mattress pump system is disclosed. The pump system includes a number of standard components with a few inexpensive varied components to allow for easy and less expensive use of the pump with mattresses having varying numbers of inflatable zones. An improved sealed manifold is also disclosed.

### CROSS REFERENCE TO RELATED APPLICATIONS

This application is a continuation-in-part of and claims the benefit under 35 U.S.C. §120 of U.S. application Ser. No. 11/869,334, filed Oct. 9, 2007, now U.S. Pat. No. ______, which claims priority under 35 U.S.C. §119 to U.S. Provisional Application No. 60/897,616, filed Jan. 26, 2007. The foregoing applications are both specifically incorporated herein by reference for all purposes.

### FIELD OF THE INVENTION

This invention relates generally to the field of air mattresses. More specifically, it relates to a pump system that can be used with mattresses having a varying number of individually-inflatable zones. The pump system has a common platform and a manifold that can accommodate a range of pump sizes, differing numbers of air control valves, and varied configurations of faceplates for easy and cost-effective manufacturing and use with mattresses that have different numbers of inflatable zones.

### BACKGROUND

Pumps for mattresses are well known for providing controlled air flow to inflatable mattresses. One such system is disclosed in U.S. Pat. No. 5,044,029 to Vrzalik. Vrzalik teaches an air control system wherein the bed and frame itself incorporates the system, and therefore greatly increases the cost of manufacturing by requiring integration of the controls into the mattress. Another air control mechanism, which is external to the bed itself, is disclosed in U.S. Pat. No. 6,037,723 to Schafer. A major limitation of this and other similar air control systems is that the systems can inflate only the specific number of chambers for which they are designed, and can therefore be used only with mattresses containing the matching number of inflatable chambers. Separate pumps therefore need to be manufactured for each type of mattress model.

The requirement for existing pumps to be customized to accommodate the number of inflatable chambers in the mattress with which they will be used greatly increases manufacturing costs and time, and decreases overall market efficiency by requiring a unique pump for each style of bed. None of the existing airbed control systems currently in use provide an interchangeable, efficient pump system, but rather are manufactured and sold with substantial differences in appearance, internal design, and component configuration for use with mattresses with varying numbers of zones. The mechanical and software designs presently used are typically single-pump based and require a manufacturer to create new tool sets for internal components, new circuit board designs, and new external enclosures to create the different pump systems with respect to the number of air zones to be controlled. Existing pump systems do not lend themselves to the development or sale of a comprehensive product line that can be easily and cost-effectively configured to produce multiple finished products that have significantly differentiated functionality but a consistent overall appearance.

Accordingly, a need exists for a multiple configuration pump system in which a variety of pump sizes and face plates as well as varying number of air control valves can be incorporated into a standard platform and manifold for use with mattresses having different numbers of inflatable zones. This system provides the components that are the most expensive to tool as the common universal components, and the least expensive and simply-tooled components to be the variable ones. Inventory can be built to a nearly-finished state, and quickly and inexpensively configured with the variable components at the last moment based on actual market demand.

Furthermore, such a system solves the current problems of an increased expense of manufacturing multiple types of pump systems for use with mattresses having different numbers of zones, and also provides a universal pump for convenience of retailers and consumers. A multiple configuration system also allows for streamlined testing procedures and lower testing costs, such as standard durability drop tests, form, fit and function tests, and compliance tests across the configurations. The standardized pump systems also allow for use of the same packaging for each pump system, including both the inner packaging and outer shipping box, fewer inventory SKUs, standardized packaging lines, processes and employee training, and standardized pallet size and storage requirements.

A need also exists for a sealed manifold for such an air pump system. Pumps for mattresses are well known for providing controlled air flow to inflatable mattresses, however, current pumps are not capable of accurately controlling pressure in the chamber of the manifold. Repeatable accuracy is important in devices aimed at long-term care facilities and other medical applications where accurate control of sleep surface firmness plays a direct role in avoiding pressure sores. Currently, medical grade products which posses this required level of control are orders of magnitude more expensive than consumer level products. Additionally, air leaks through the pump have historically been a perceived weakness of the air chamber type systems. For example, a single hair or dust bunny in the sealing port could cause a chamber leak in such models. A manifold that employs air control valves that use a reinforced or redundant sealing system provides greatly enhanced pressure control and precludes air leaks in the system.

### SUMMARY

The present invention provides a multiple configuration mattress pump. The pump system includes a manifold which is adapted to connect a varying number of air control valves to control air flow to the related number of inflatable mattress zones. The platform can accommodate a variety of pump sizes. Additionally, the platform is adapted to easily hold changeable faceplates containing a number of tube holes corresponding to the number of mattress zones. The number of plugs used to fill the holes in the manifold for unused air control valves for use with beds having fewer than the maximum number of zones can vary. The pump system includes a circuit board which fits onto the platform, the software of which can be programmed to match the number of air control valves corresponding to each inflatable zone. The invention may include a wired or wireless pendant connected to the circuit board of the platform, allowing the user to control the airflow in each inflatable zone. The invention may also include a pony board with a number of connection ports equal to the maximum number of air control openings in the manifold, with the output wires contained in a single arm and allowing for a single connection from the valves to the circuit board where multiple valves are used.

The present invention has several advantages and benefits over the prior art. Other objects, features and advantages of the present invention will become apparent after reviewing the following detailed description.

### BRIEF DESCRIPTION OF THE DRAWINGS

FIG. 1 is a side perspective view of an air mattress pump system in accordance with one embodiment of the present invention shown without an enclosure top and with certain details removed;

FIG. 2 is a top view of a pump system in accordance with one embodiment of the present invention shown without an enclosure top;

FIG. 3 is a detail side perspective view of a pump system in accordance with one embodiment of the present invention shown without an enclosure top;

FIG. 4 is a front perspective view of a manifold, air control valves, a pony board and an air pump in accordance with one embodiment of the present invention;

FIG. 5 is a front perspective view of three configurations of pump systems with enclosure tops;

FIG. 6 is a top view of the three configurations of pump systems of FIG. 5, shown without enclosure tops;

FIG. 7 is a rear perspective view of a manifold and a faceplate in a two-zone configuration of a pump system;

FIG. 8 is a rear perspective view of a manifold and faceplate in a six-zone configuration of a pump system;

FIG. 9 is a front perspective view of a manifold, zone tubing and faceplates of two configurations of pump systems shown without enclosure tops;

FIG. 10 is a rear view of a manifold with an air control valve and air control plugs in accordance with one embodiment of the present invention;

FIG. 11 is a top perspective view of an air control valve in accordance with one embodiment of the present invention;

FIG. 12 is a top view of a platform of a pump system in accordance with one embodiment of the present invention;

FIG. 13 is an underside view of a top enclosure of a pump system in accordance with one embodiment of the present invention;

FIG. 14 is a top view of a manifold, a pony board, air valves, and air valve connective wires in accordance with one embodiment of the present invention;

FIG. 15 is a side perspective view of a manifold and tubing of a pump system in accordance with one embodiment of the present invention;

FIG. 16 is a side perspective view of a pendant circuit board in accordance with one embodiment of the present invention, shown with the cover removed;

FIG. 17 is a side perspective view of a pendant attached to a pump system with an enclosure top in accordance with one embodiment of the present invention;

FIG. 18 is an exploded isometric view of the back of a manifold and solenoid assembly in accordance with one embodiment of the present invention;

FIG. 19 is a cross-section of a side view of the assembled manifold of FIG. 18 showing a solenoid assembly engaged in an air control hole; and

FIG. 20 is an enlarged view of the cross-section of the solenoid assembly shown in FIG. 19.

### DETAILED DESCRIPTION OF THE PREFERRED EMBODIMENTS

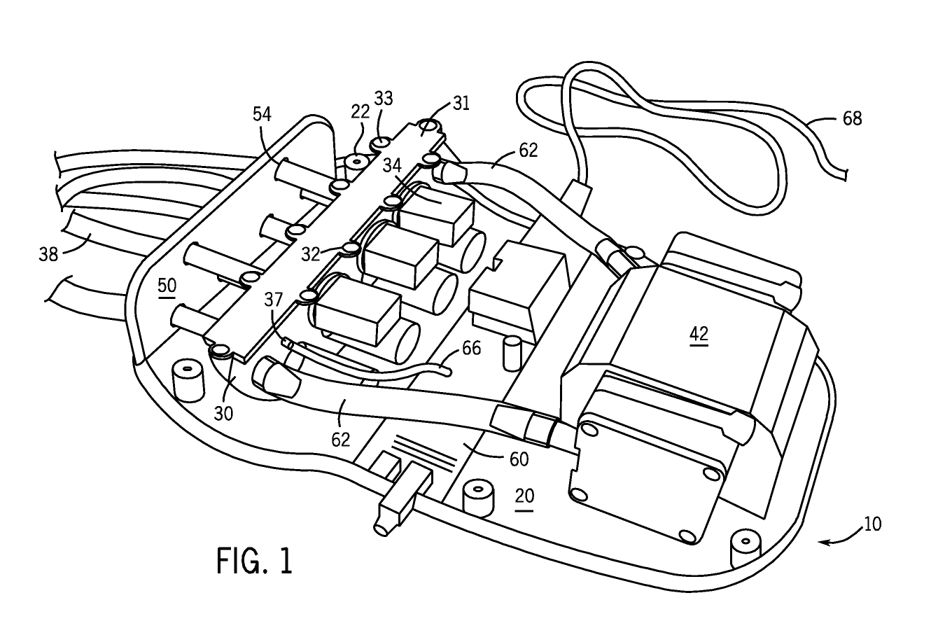

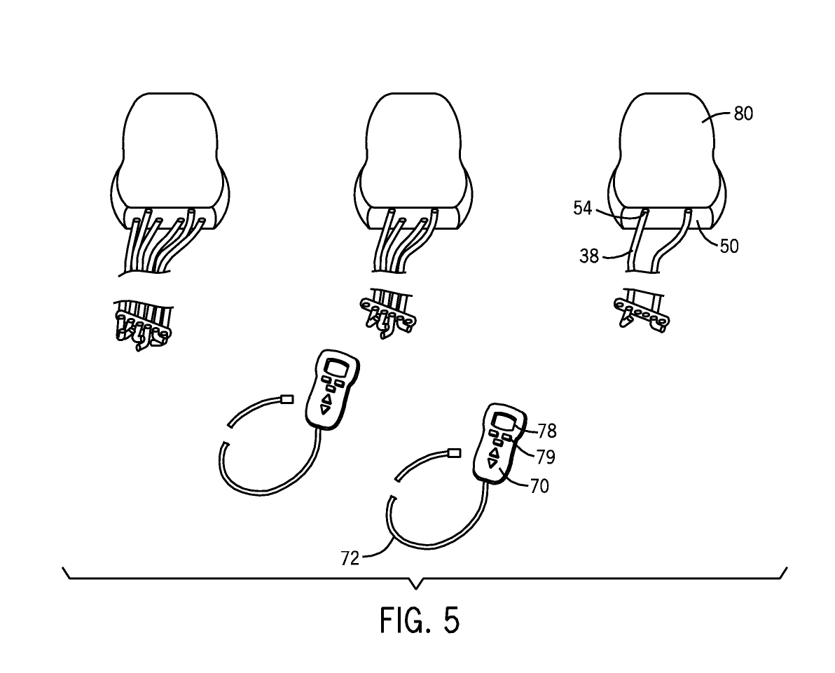

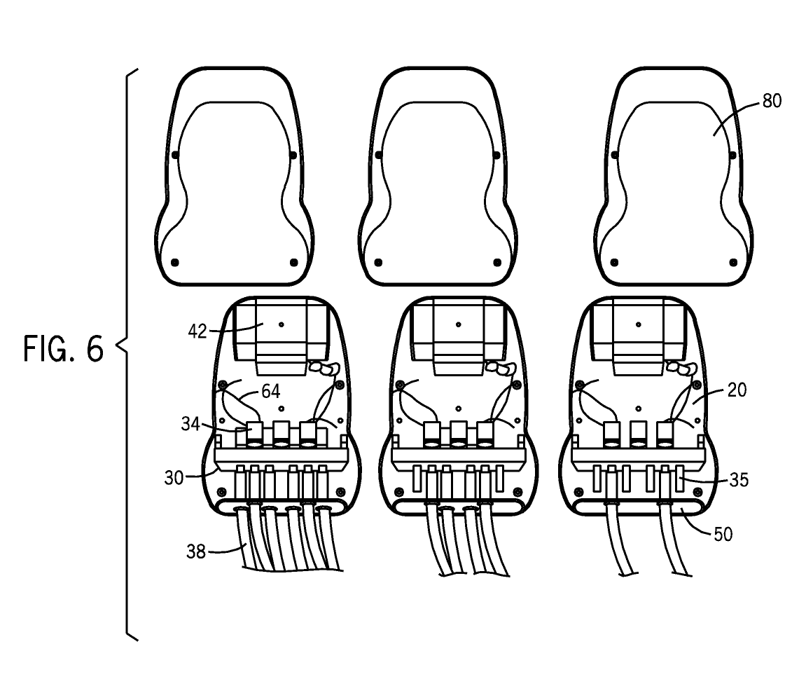

Referring now to the drawings, FIGS. 1-6 are views of a multiple configuration airbed pump system 10 in accordance with a preferred embodiment of the present invention. The pump system 10 may include a pump casing consisting of a platform 20 and an enclosure top 80. The system may further include a manifold 30 for controlling airflow and including air valves 35 and a pressure measurement valve 37, air control valves 34, air control plugs 36, zone tubing 38, a pump mounting area 40 for receiving a pump 42, an interchangeable faceplate 50, a primary circuit board 60, internal tubing 62, a pressure measurement tube 66, a pendant 70, and a pony board 100. The air valves 35 and pressure measurement valve 37 include air inlets, outlets, or ports. The platform 20, manifold 30, mounting base 40, circuit board 60, internal tubing 62, pressure measurement tube 66, pendant 70, pump 42, pony board 100, and enclosure top 80, are the shared components of the system, and can be used with mattresses varying from one to six individual inflatable zones. Of course, the system 10 could be used with mattresses having other numbers of zones if desired by modifying the manifold 30 to include additional air valves 35. The faceplate 50, number of air control valves 34, zone tubing 38, and number of air control plugs 36 are the only components that vary in the use of the system 10 with different mattresses. The software of the circuit board 60 can be programmed to correspond to the number of zones to be inflated.

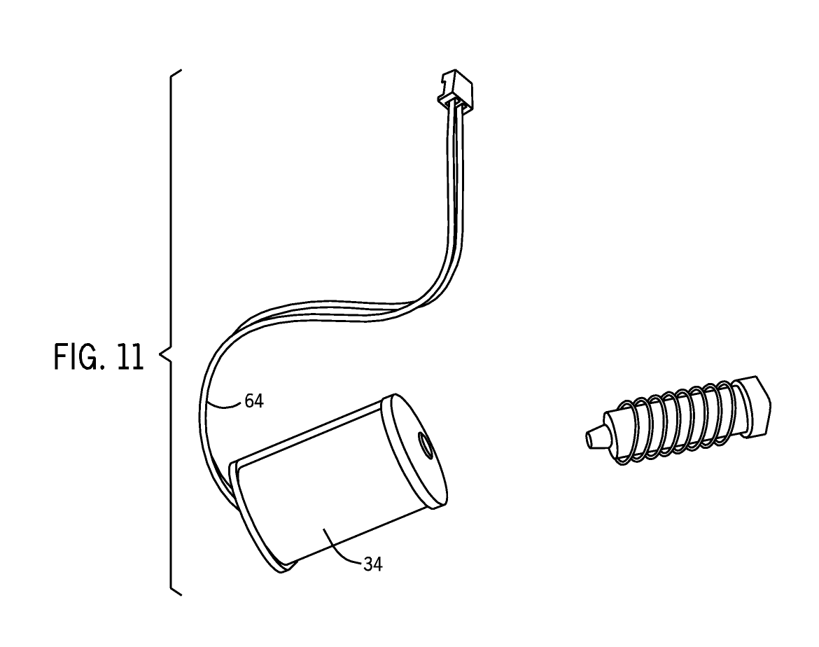

As seen in FIGS. 1-3, the manifold 30 and circuit board 60 can be mounted to the platform 20, and the platform 20 may have a pump area 40 for holding a pump 42. The use of a manifold 30 is well-known in the art as a component for regulating air flow pumped from a pump 42 to air chambers. A diaphragm pump is shown, but other types of pumps could be used. The platform 20 can also include a slot 52 for holding an changeable faceplate 50. The platform 20 may also include screw holes 22 for attaching the manifold 30 and circuit board 60. The platform 20 may also include screw holes 44 for attaching the pump 42, as well as screw holes 23 for attaching the enclosure top 80 (FIG. 11). Of course, other means of attaching the enclosure top 80 to the platform 20, such as adhesives, sonic welding, or snap-fitting, may also be used.

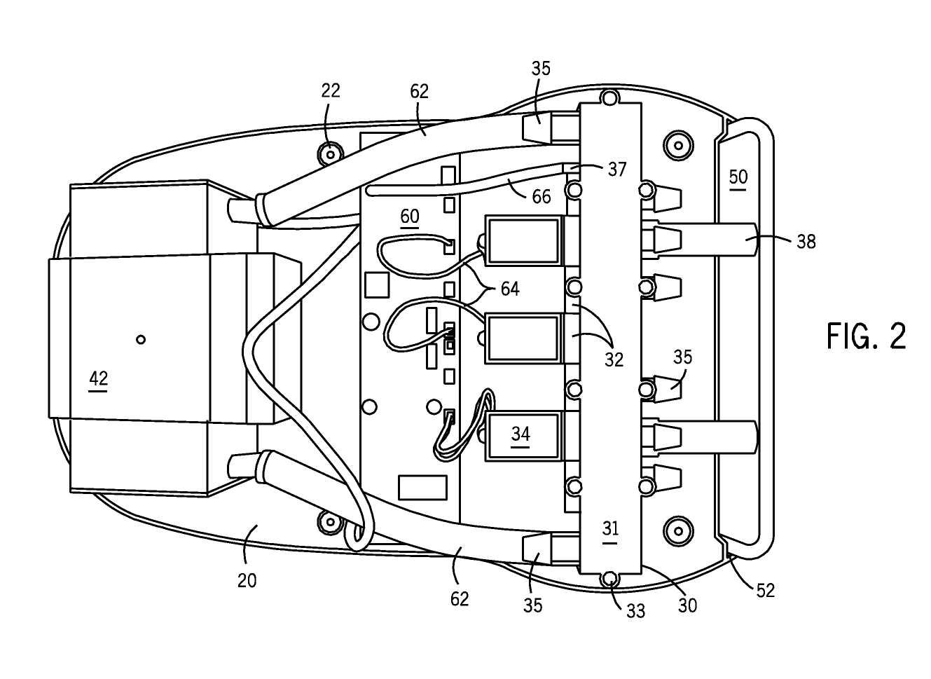

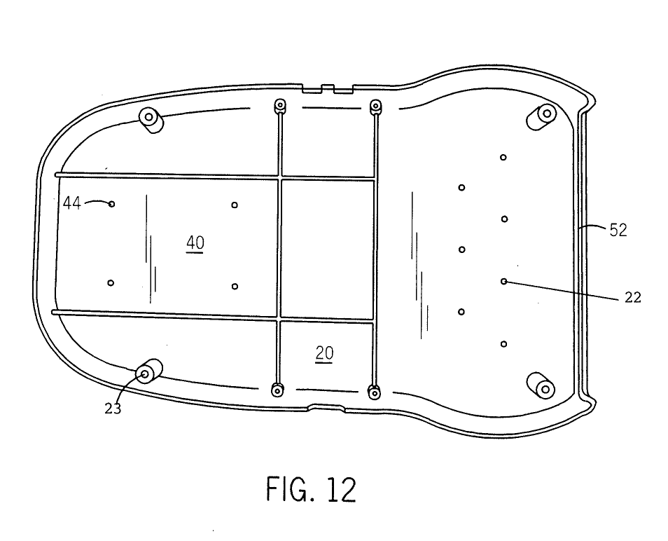

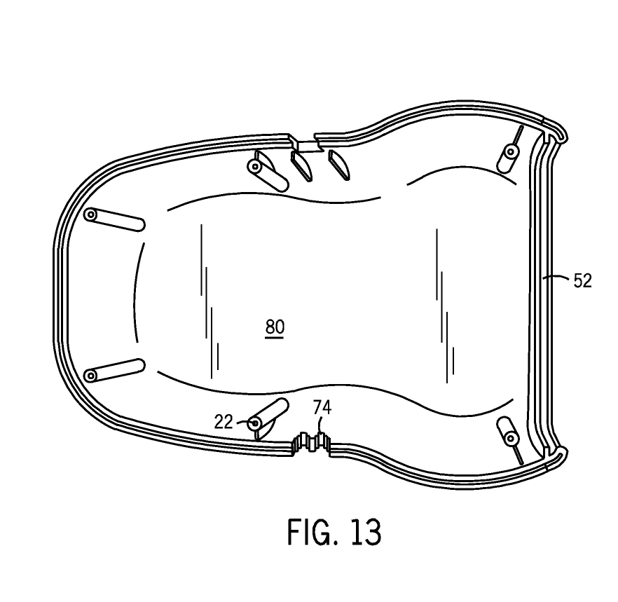

As seen in FIG. 2, the assembled pump system 10 with the enclosure top 80 secured to the platform 20 is identical for pump systems 10 used with, for example, six-, four-, and two-zone mattresses, with the exception of the faceplate 50 and number of zone tubes 38 exiting the faceplate 50. This allows continuity in the overall product line, in addition to the cost savings, in using such an interchangeable pump system 10. As the casing platform 20, enclosure top 80, and manifold 30 (FIGS. 12-13) are three of the more intricate and therefore expensive components to tool in manufacturing, the standardization provides cost savings by allowing these expensive components to be used across the entire product line, with any mattress model. The standardized platform 20 and enclosure top 80 casing also allow for standardized packing, shipping, and storage of the pump systems 10 to be used with the varying mattress models. The standardized casing also provides brand equity by keeping the same overall look across multiple price points and SKUs, and also provides packaging and advertising cost savings.

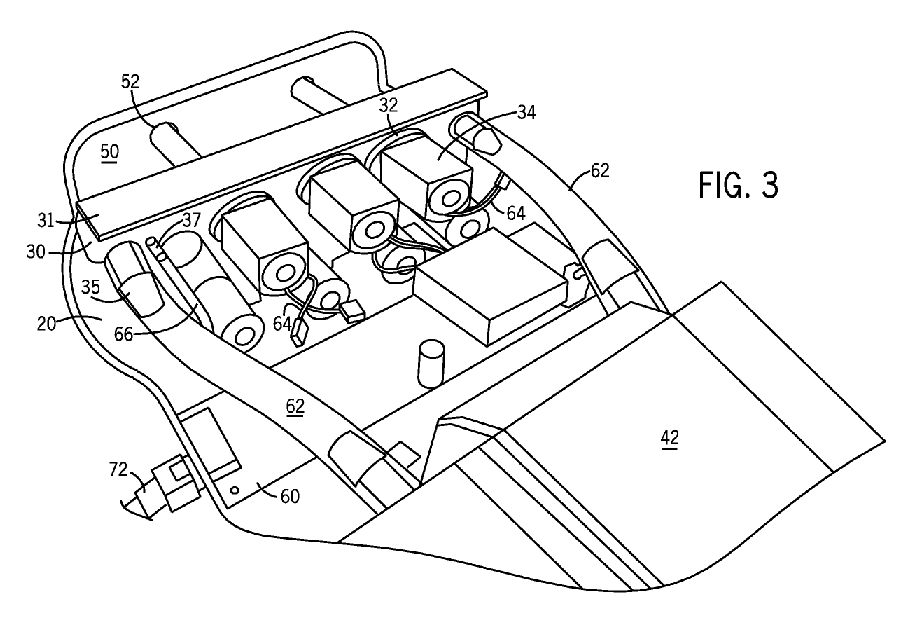

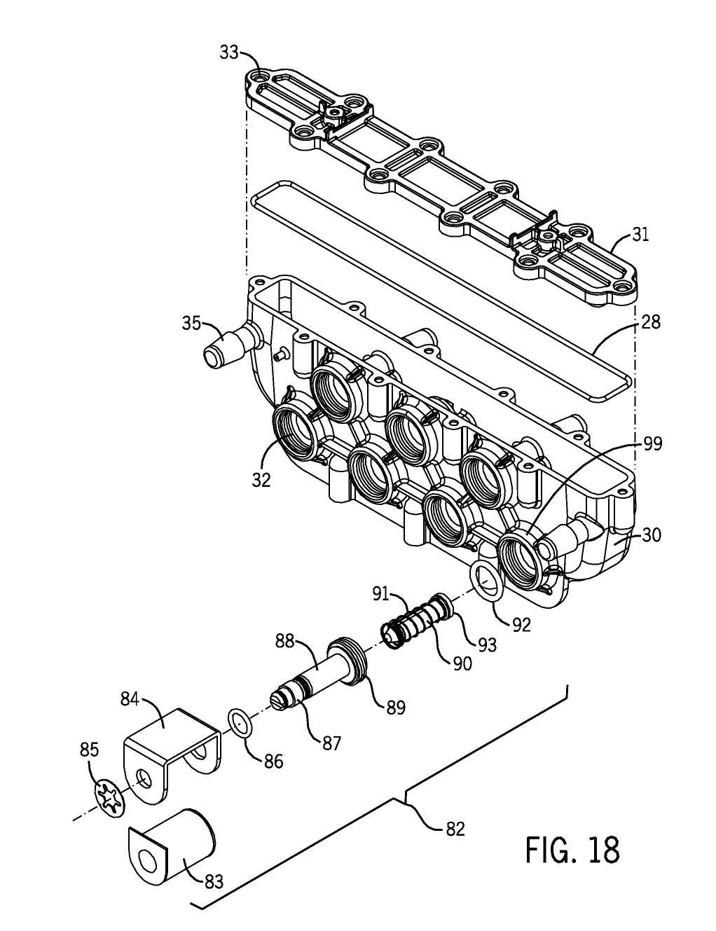

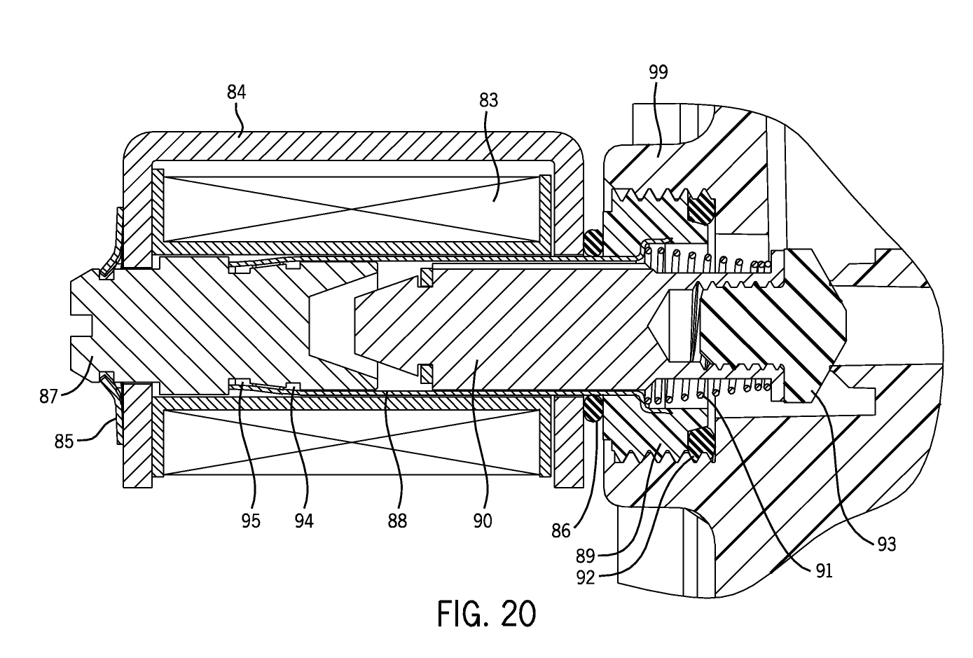

Referring now to FIGS. 3-4, 7-8 and 10, one side of a manifold 30 includes air control holes 32. In the embodiment shown, seven air control holes 32 are shown. This allows up to seven air control valves 34 to be inserted into the holes 32 of the manifold 30 for a six-zone mattress, with six air control valves 34 used for air flow to the zones, and one air control valve 34 for exhaust. In FIG. 11, solenoid valves are shown but other types of air control valves 34 could be used. See, e.g., FIGS. 18-20 and related discussion. Of course, manifolds 30 with more or fewer air control holes 32 could be manufactured to accommodate mattresses with more or fewer than six inflatable zones. The manifold 30 includes a cover 31 which can be connected with screws using manifold screw holes 33. There may also be a manifold gasket 28 between the manifold cover 31 and the manifold 30. A manifold gasket 28 may help with sealing the manifold and preventing air leaks. In one embodiment, shown in FIGS. 18-20, the manifold cover 31 also has a groove 29 to help secure and compress the manifold gasket 28 between the manifold 30 and manifold cover 31. The inclusion of a groove 29 in the manifold cover 31 creates a substantially more airtight seal between the manifold cover 31 and the manifold 30 because it tolerates molding irregularities better than other types of gasketing options and allows for a lower cost manufacturing and assembly option while still preserving the option for disassembly and repair. Other methods of sealing the manifold cover 31 to the manifold 30 include solvent bonding, heat or sonic welding, and sealing adhesives.

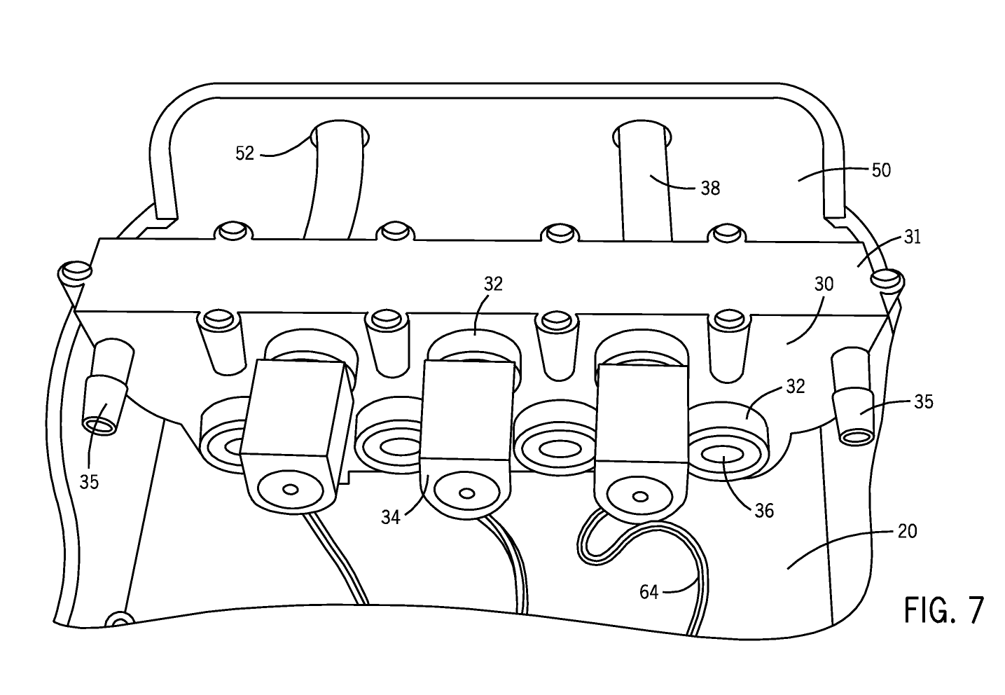

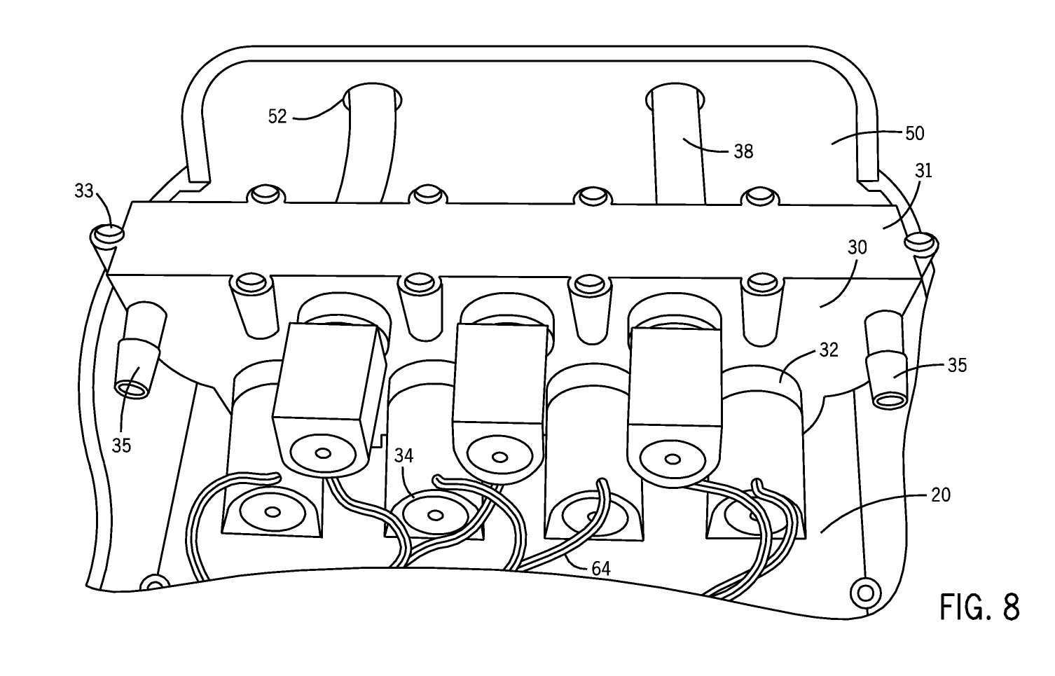

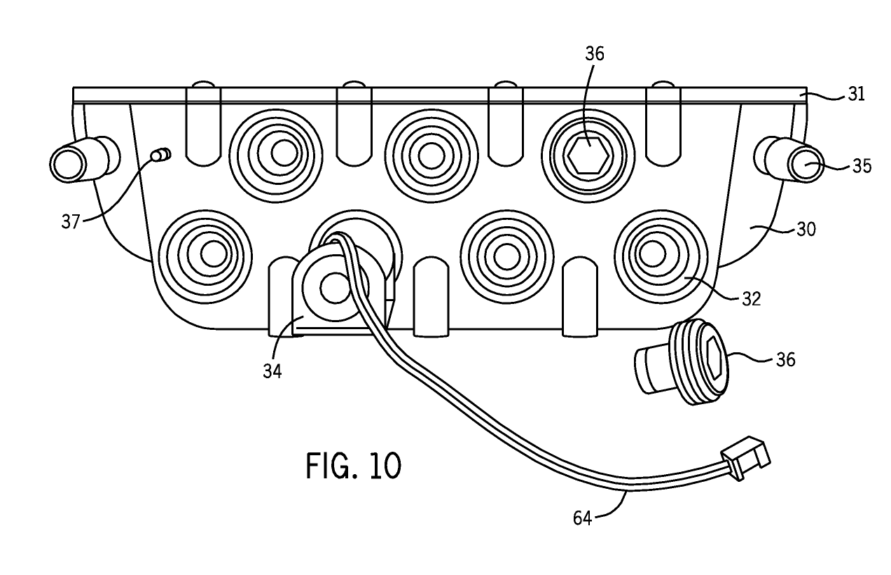

Having a standardized manifold 30, the most expensive component due to its complexity and detailed tooling, provides a large cost savings. When fewer than the maximum number of zones are being inflated, the corresponding number of air control valves 34 can be used, and air control plugs 36 can be used to block the empty holes 32 not being used. For example, in the embodiment shown, in a mattress with only two zones, three air control valves 34 would be used (two for air flow to the zones, one for exhaust), and four air control plugs 36 would be inserted into the four unused holes 32. FIG. 7 shows a system 10 configured for a two-zone mattress, with the manifold 30 having three air control valves 34 and four air control plugs 36 blocking the unused holes 32. FIG. 8 shows a system 10 configured for a six-zone mattress, with the manifold 30 having seven air control valves 34 and therefore no air control plugs 36. The air control plugs 36 (FIG. 10) fit any hole 32 in the manifold 30 and are very inexpensive to manufacture; having these air control plugs 36 as one of the variable components therefore allows for only a small cost to change the configuration for use with different mattress models. It also allows for volume discounts, in that the same parts can be used across different SKUs.

As seen in the embodiment shown in FIGS. 1-3, two air valves 35 are connected by internal tubing 62 to the pump 42, whereby air is pumped from the pump 42 to the manifold 30. On the opposite side of the manifold 30, air valves 35 are coupled to each of the seven holes 32. For each zone of the mattress that is to be inflated, a zone tube 38 is attached to the air valve 35 opposite an air control valve 34 and runs to an inflatable zone of the mattress. The manifold 30 is one of the more difficult and expensive components to tool for manufacturing, but, by simply plugging any unused holes 32 with plugs 36, the manifold 30 can be used with beds ranging from, in the embodiment shown in the FIGS., one to six inflatable zones without any additional manufacturing or machining costs.

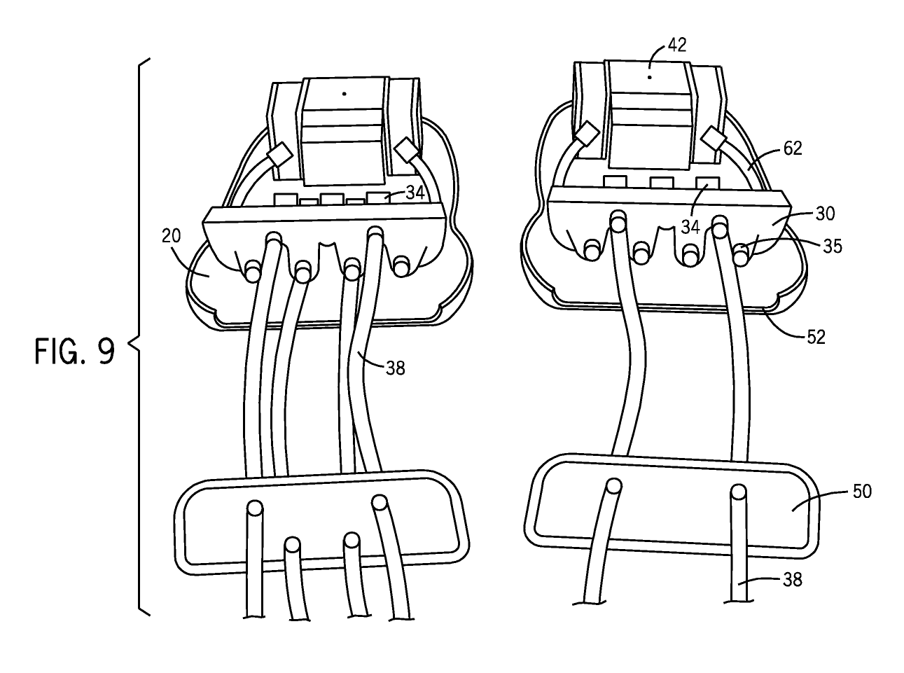

Referring now to FIGS. 1, 6, and 9, the faceplate 50 includes openings 54 through which the zone tubes 38 can pass. In a preferred embodiment, the faceplate 50 fits into a slot 52 in the casing platform 20 and top enclosure 80. Faceplates 50 can therefore be changed to accommodate the number of zone tubes 38 (and air control valves 34) corresponding to the number of inflatable zones in each particular mattress. Where a mattress has four inflatable zones, for example, a faceplate 50 with four openings 54 would be placed in the slot 52, and four tubes 38 would run from the air valves 35 opposite the air control valves 34, through the openings 54 and to each zone of the mattress. The faceplates 50 are a small and inexpensive component of the pump 10, and requiring only this component to be manufactured differently for use of the pump 10 with different mattresses saves time and money. Additionally, the faceplate 50 protects the tube 38 connections to the air valves 35. Some pump systems currently on the market have the tube connections exposed, which subjects the existing pump systems to a greater risk of breakage. This “hiding” of the internal components in the pump system 10 of the present invention also adds aesthetic value to the system 10 giving it an overall clean, finished look.

The platform 20 in a preferred embodiment also includes a pump mounting area 40 for supporting a pump 42. A diaphragm pump is shown, but other types of air pumps could also be used. The mounting area 40 in the embodiment shown in FIG. 12 includes four pump screw holes 44 by which the pump 42 can be secured. Of course, the mounting area 40 could be configured differently and include a different number and configuration of pump screw holes 44 depending on the pump 42 used. Alternative methods of securing the pump 42 to the mounting area 40 of the platform 20 could also be used. The mounting area 40 is sized such that a variety of types and sizes of pumps 42 can be used with the pump system 10. Internal tubing 62 connects the pump 42 to the manifold 30 to pump air from the manifold 30 to the mattress zones.

As seen in FIGS. 1-3, a circuit board 60 may also be affixed to the platform 20. The circuit board 60 contains software programmable for the varying number of zones to be inflated. It also contains all connection assemblies for system power and for the pendant 70 used by the mattress user to control the inflation of the zones. The air control valves 34 can be connected to the circuit board 60 by connective wires 64, and air flow is controlled by the user selecting desired firmness on the pendant 70 which is connected to the circuit board 60. This allows the corresponding amount of air to be pumped to each zone based on the firmness level selected by the user on the pendant 70. A pressure measurement tube 66 connects a pressure measurement valve 37 on the manifold 30 to the circuit board 60 to allow the software to determine the pressure in the manifold 30 to control the proper release of air for the firmness selected by the user. The circuit board 60 can be used for any configuration of air control valves 34 and pump sizes 42 by loading it with the appropriate software program. A power cord 68 may be attached to the circuit board 60 to provide power to the pump system 10. The power cord 68 may alternatively be attached through a transformer (not shown) depending on circuitry design. In a preferred embodiment, the power cord 68 passes through the top enclosure 80 and/or the platform 20 of the casing.

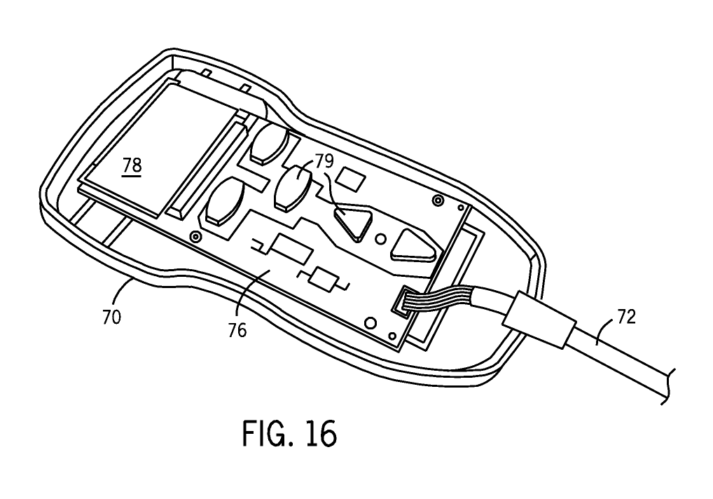

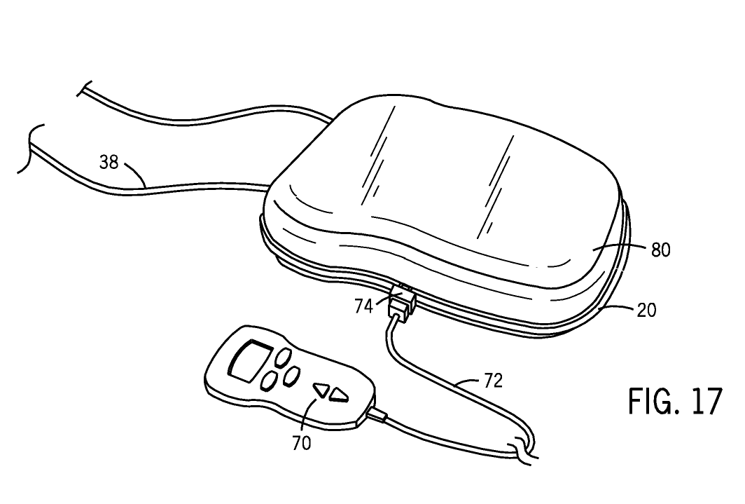

As shown in FIGS. 1 and 16-17, a pendant 70 can be connected to the circuit board 60 via a pendant cord 72. An aperture 74 in the enclosure top 80 allows the pendant cord 72 to pass through the enclosure top 80 for connection to the circuit board 60. Alternatively, the pendant 70 may be configured with the circuit board 60 for wireless control of the pump system 10 (not shown). The pendant 70 includes a pendant circuit board 76 onto which pendant software is uploaded. The pendant 70 and pendant software are standard and can be can be used in connection with any pump system 10 configuration; the pendant 70 and pendant software are designed such that a pendant 70 can be plugged into the circuit board 60 of any pump system 10 configuration and allow the user to control the number of zones in her or her particular air mattress. The pendant 70 includes an LCD display 78 and control buttons 79 to allow the user to control the amount of air pumped from the pump 10 to each inflatable zone. The size of the LCD display 78 and number of control buttons 79 can of course vary. Alternatively, the LCD display 78 could be a touch screen on which firmless level is selected, or a track wheel or ball could be used for selection by a user. Multiple pendants 70 could also be used depending on the need for individual controllers in the system.

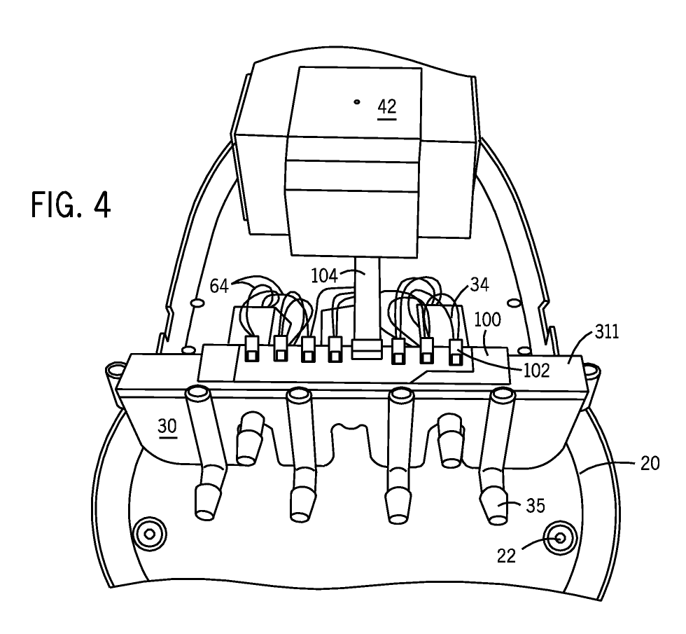

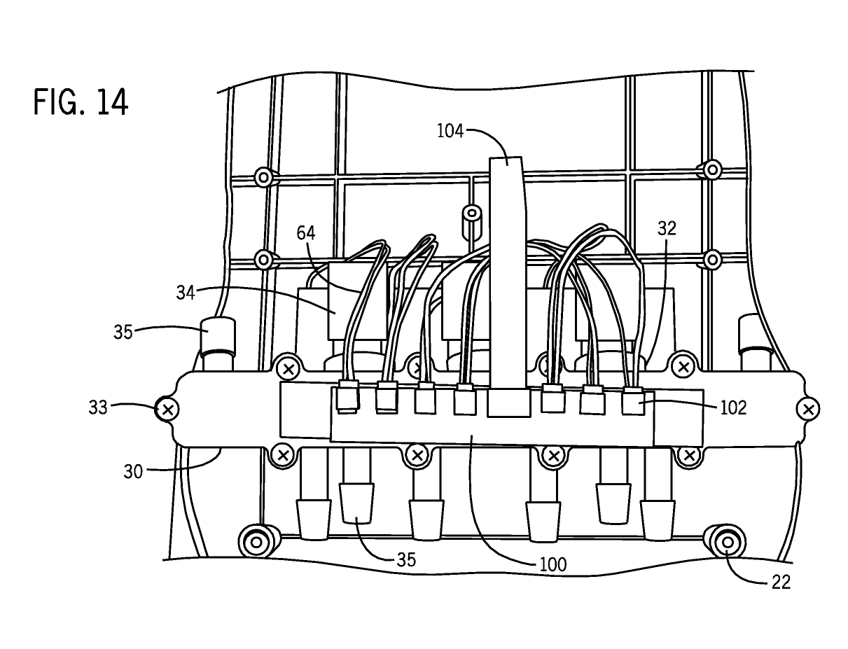

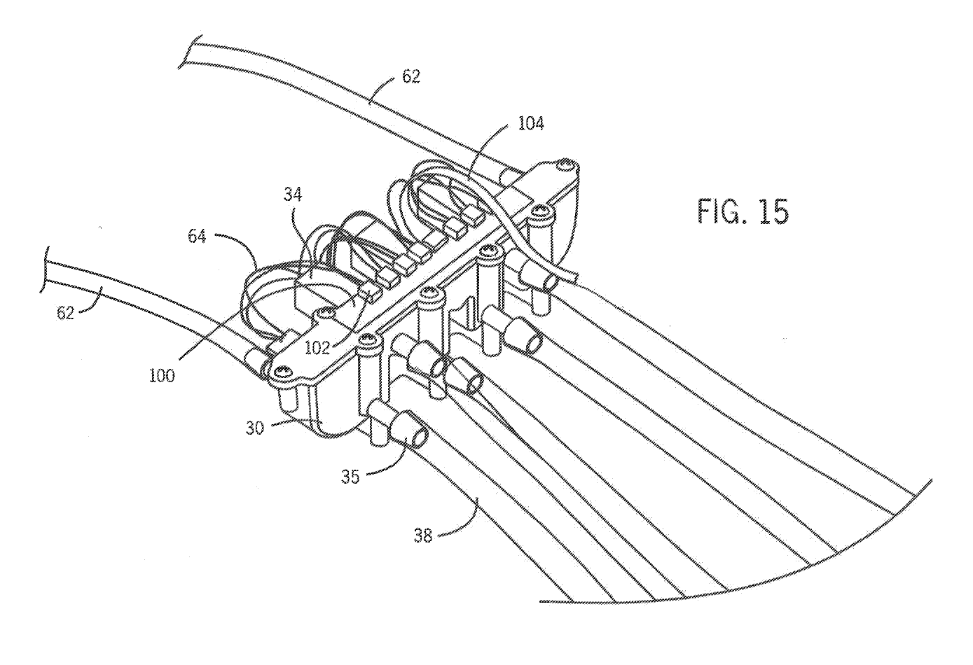

As seen in FIGS. 4 and 14-15, the air control valves 34 may be connected to the circuit board 60 through a pony board 100 instead of directly to the circuit board 60 itself. In this embodiment, connective wires 64 connect the air control valves 34 to the pony board 100, which is then connected to the circuit board 60. The pony board 100 may be attached to the cover 31 of the manifold 30 by screws. This pony board 100 includes connection ports 102 equal to the maximum number of air control holes 32 in the manifold 30 and an output arm 104. In the embodiment shown in the FIGS., the pony board has seven connection ports 102, equal to the number of air control holes 32 in the manifold 30 shown. Of course, the pony board 100 could include a different number of ports 102 to accommodate the number of holes 32 in the manifold 30. The pony board 100 allows each air control valve connective wire 64 to be plugged into the pony board 100 instead of directly into the circuit board 60, with a single output arm 104 running from the pony board 100 to the circuit board 60. The output arm 104 provides for a single connection from the valves 34 to the circuit board 60 where multiple valves 34 are used, making connection of the pump 10 components faster and easier. It also provides for faster and simpler external testing of the valves 34 and manifold 30 by allowing connection of the single output arm 104 of the pony board 100 to a separate testing unit.

Air control holes 32 into which air control valves 34 are inserted can be a source of air leaks, and the system can be optimized using air control valves 34 that form a strong seal with the manifold 30. FIGS. 18-20 show an embodiment of a manifold 30 in which the air control valves 34 form a strong seal with the manifold overmolding 99 to avoid such air leaks. The air control valve 34 in FIGS. 18-20 is a solenoid assembly 82. The solenoid assembly 82 shown includes a solenoid coil 83, a solenoid frame 84, a retaining clip 85, a first solenoid o-ring 86, a plunger stop 87, a carrier sleeve 88, carrier overmolding 89, a plunger 90, a return spring 91, and a second solenoid o-ring 92. The solenoid coil 83 is typically an electrical wire coil attached to an electrical source. The solenoid frame 84 can be made from any material permeable to magnetic flux and is preferably made from steel. The carrier sleeve 88 may be made from any non-magnetic metal but is preferably made from copper or brass. The carrier overmolding 89 may be made from any non-magnetic material, and preferably is made from a high temperature resistant thermoplastic. The plunger stop 87 and plunger 90 is preferrably made from a high quality, high magnetically permeable iron with limited residual magnetic retention properties. The first solenoid o-ring 86 and the second solenoid o-ring 92 can be made from a variety of types of temperature resistant rubber or plastic, including nitrile. The retaining clip 85 and return spring 91 could be made from any suitable material including, but not limited to, a variety of metals, plastic, or rubber. The return spring 91 should be made from high temperature, non-magnetic material, such as 302 Stainless Spring Wire.

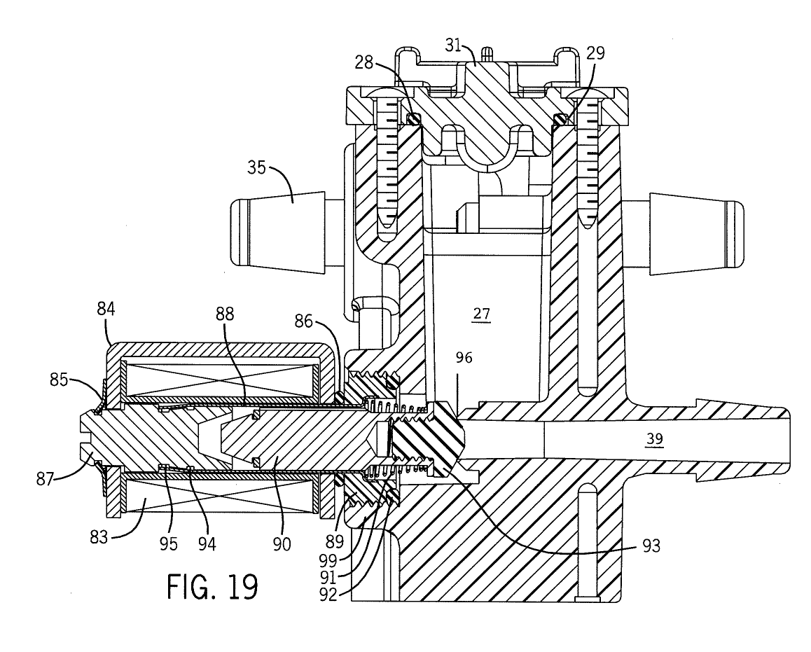

Further detail of the solenoid assembly 82 is shown in FIG. 19. In the solenoid assembly 82 shown, the plunger stop 87 is positioned partially within the carrier sleeve 88. There are two grooves around the mid-section of the plunger stop 87 that form two moats, namely the first moat 94 and second moat 95, between the plunger stop 87 and the carrier sleeve 88. These moats are filled with a sealant to provide a strong seal between the plunger stop 87 and the carrier sleeve 88. Whatever sealant is used should be able to withstand high temperatures since temperatures in the solenoid assembly 82 may be significant, for example, around 85-90° C., depending on the frequency and duration of the operation of the system. Many suitable sealants could be used, but a particularly effective sealant is Loctite® branded 620, a selant from Henkel Corporation, which is specifically designed for high temperature environments. During assembly, the carrier sleeve 88 is dipped in the sealant and swaged onto the plunger stop 87; this causes the sealant to fill the moats, sealing the assembly.

The plunger 90 also fits partially inside the carrier sleeve. The plunger 90 has a plunger head 93 that is screwed or otherwise attached into the end of the plunger that is opposite the plunger stop. The plunger head 93 is shaped such that it blocks the valve seat 96 into which it is inserted when the plunger 90 is in a closed position. The return spring 91 surrounds the plunger 90 and is compressed when the plunger 90 is in a closed position so that no air can pass when the solenoid assembly 82 is not energized.

A carrier overmolding piece 89 surrounds the outside of the carrier sleeve 88 on the end of the carrier sleeve that surrounds the plunger 90. The carrier overmolding 89 is threaded such that it can be screwed into or connected to the air control hole 32, which is threaded or otherwise shaped to receive the carrier overmolding and solenoid assembly 82. The first solenoid o-ring 86 and second solenoid o-ring 92 are positioned on each side of the carrier overmolding 89 and compressed to form seals that prevent air leaking from the air control hole pathway. The first solenoid o-ring 86 is compressed between the carrier overmolding 89, carrier sleeve 88, and the solenoid frame 84. The second solenoid o-ring 92 is compressed between the air control hole 32 and the carrier overmolding 89. This system of employing moats, sealant between the carrier tube and plunger stop, and compressed o-rings 86, 92 on either side of the carrier overmolding 89 creates a reinforced seal between the carrier sleeve and the plunger stop 87. The default position for the solenoid assembly and in particular the plunger head 93 is that the return spring 91 will be compressed and the plunger head 93 will be blocking the air control hole 32 due to pressurized contact between the plunger head 93 and the valve seat 96. When the solenoid coil 83 is energized, the plunger 90 will be retratcted until stopped by the plunger stop 87, therefore opening the valve seat 96 and allowing air to pass through the manifold chamber 27, through the interior space of the air valve 39, and through the zone tubing 38. Other sealing methods and air control valves and devices could be used to seal air pathway around the air control valves 34 and control the flow of air into the manifold as well.

The combination of compressed first and second soleinoid o-rings 86, 92, compressed manifold gasket 28, and sealant-filled first and second moats 94, 95 creates a reinforced sealed manifold. This reinforced sealing isolates the manifold chamber 27 from outside of the manifold, which acts as a redundant seal for zone tubing 38, even in the event of a leak at the seal created by plunger head 93 and valve seat 96.

Although the invention has been herein described in what is perceived to be to most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description herein.

What is claimed is:

1. A manifold for an air pump for providing air to a plurality of zones, the manifold comprising:
a manifold housing, the housing having a chamber with walls having a plurality of air control holes to which air control valves can be attached, and wherein air control valves are capable of being operably connected to air tubes;
a manifold cover, the manifold cover enclosing the chamber;
one or more air control valves, wherein each air control valve is operably connected to an air control hole and where the air control valve creates a reinforced seal with its corresponding air control hole; and
wherein the manifold is customizable to the number of zones by relating the number of air control valves to the number of zones and by relating the number of air tubes to the number of zones.

2. The manifold of claim 1 further comprising a gasket compressed between the manifold housing and a groove in the manifold cover.

3. The manifold of claim 1 wherein an air control valve comprises:
a carrier sleeve, the carrier sleeve being operably connected to an air control hole by carrier overmolding;
a solenoid coil surrounding the carrier sleeve;
a plunger stop, the plunger stop being at least partially engaged inside the carrier sleeve and having grooves that form moats enclosed by the carrier sleeve and filled with a sealant; and
a plunger that can be retracted to or pushed away from the plunger stop when the solenoid coil is energized, the plunger having a plunger head capable of blocking the air control hole.

4. The manifold of claim 3, further comprising compressed gaskets on each side of the carrier overmolding.

5. A manifold for an air pump for providing air to a plurality of zones, the manifold comprising:
a manifold housing, the housing having a chamber with walls having a plurality of air control holes to which air control valves can be attached, and wherein air control valves are capable of being operably connected to air tubes;
a manifold cover, the manifold cover enclosing the chamber;
a gasket between the manifold housing and the manifold cover and compressed in a groove in the manifold cover;
one or more air control valves, wherein each air control valve is operably connected to an air control hole and where the air control valve creates a reinforced seal with its corresponding air control hole; wherein the air control valve comprises:
a carrier sleeve, the carrier sleeve being operably connected to an air control hole by carrier overmolding;
a solenoid coil surrounding the carrier sleeve,
a plunger stop, the plunger stop being at least partially engaged inside the carrier sleeve and having grooves that form moats enclosed by the carrier sleeve and filled with a sealant; and
a plunger that can be retracted to or pushed away from the plunger stop when the solenoid coil is energized, the plunger having a plunger head capable of blocking the air control hole; and
wherein the manifold is customizable to the number of zones by relating the number of air control valves to the number of zones and by relating the number of air tubes to the number of zones.

6. An air control valve for use with a manifold for an air pump comprising:
a carrier sleeve, the carrier sleeve being operably connected to an air control hole by carrier overmolding;
a solenoid coil surrounding the carrier sleeve;
a plunger stop, the plunger stop being at least partially engaged inside the carrier sleeve and having grooves that form moats enclosed by the carrier sleeve and filled with a sealant; and
a plunger that can be retracted to or pushed away from the plunger stop when the solenoid coil is energized, the plunger having a plunger head capable of blocking the air control hole;
wherein the air control valve is strongly sealed.

7. The manifold of claim 6, further comprising compressed gaskets on each side of the carrier overmolding.
